(19) United States
(12) Patent Application Publication
(10) Pub. No.: US 2003/0084249 A1
(43) Pub. Date: May 1, 2003

(54) Preemptive eviction of stale entries is a computer cache by use of age-bits

(76) Inventors: David J.C. Johnson, Ft. Collins, CO (US); Jonathan P. Lotz, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 10/001,586

(22) Filed: Oct. 31, 2001

(51) Int. Cl. G06F 13/00

(52) U.S. Cl. 711/133

(57) ABSTRACT

A single age-bit may provided for each line in a cache, or for each index. Each time a line, or index, is accessed, or written, the corresponding age-bit is set to a first logical state. A state machine periodically checks the status of each age-bit. If an age-bit is in the first logical state, the state machine sets the age-bit to a second logical state. If the age-bit is already in the second logical state, then the line of data corresponding to the age-bit, or at least one line in the set of lines corresponding to the index corresponding to the age-bit, has not been accessed or changed since the last time the state machine checked the age-bit, and may be preemptively evicted.

### FIELD OF INVENTION

This invention relates generally to computer systems and more specifically to cache memory systems.

### BACKGROUND OF THE INVENTION

Most computer systems employ a multilevel hierarchy of memory systems, with relatively fast, expensive, limited-capacity memory at the highest level of the hierarchy and proceeding to relatively slower, lower cost, higher-capacity memory at the lowest level of the hierarchy. Typically, the hierarchy includes a small fast memory called a cache, either physically integrated within a processor integrated circuit, or mounted physically close to the processor for speed. There may be separate instruction caches and data caches. There may be multiple levels of caches. Many computer systems employ multiple processors, each of which may have multiple levels of caches. Some caches may be shared by multiple processors. All processors and caches may share a common main memory.

Typically, a memory is organized into words (for example, 32 bits or 64 bits per word). Typically, the minimum amount of memory that can be transferred between a cache and a next lower level of the memory hierarchy is called a line, or sometimes a block. A line is typically multiple words (for example, 16 words per line). Memory may also be divided into pages (also called segments), with many lines per page. In some systems, page size may be variable. The present patent document uses the term “line”, but the invention is equally applicable to blocks or other memory organizations.

Many computer systems employ multiple processors, each of which may have multiple levels of caches. Some caches may be shared by multiple processors. All processors and caches may share a common main memory. A particular line may simultaneously exist in memory and in the cache hierarchies for multiple processors. All copies of a line in the caches must be identical, a property called coherency. The protocols for maintaining coherence for multiple processors are called cache coherence protocols.

Cache coherence protocols commonly place each cached line into one of multiple states. One common approach uses three possible states for each line in a cache. Before any lines are placed into the cache, all entries are at a default state called “Invalid”. When a previously uncached physical line is placed into the cache, the state of the entry in the cache is changed from Invalid to “Shared”. If a line is modified in a cache, it may also be immediately modified in memory (called write through). Alternatively, a cache may write a modified line to memory only when the modified line in the cache is invalidated or replaced (called write back). For a write-back cache, when a line in the cache is modified, or will be modified, the state of the entry in the cache is changed to “Modified”. The three-state assignment just described is sometimes called a MSI protocol, referring to the first letter of each of the three states.

To improve performance, the computer system tries to keep data that will be used soon in the fastest memory, which is usually a cache high in the hierarchy. Typically, when a processor requests a line, if the line is not in a cache for the processor (cache miss), then the line is copied from main memory, or from a cache of another processor. A line from main memory, or a line from another processor's cache, is also typically copied into a cache for the requesting processor, assuming that the line will need to be accessed again soon. If a cache is full, then a new line must replace some existing line in the cache. If a line to be replaced is clean (the copy in cache is identical to the copy in main memory), it may be simply overwritten. If a line to be replaced is dirty (the copy in cache is different than the copy in main memory), then the line must be evicted (copied to main memory). A replacement algorithm is used to determine which line in the cache is replaced. A common replacement algorithm is to replace the least-recently-used line in the cache.

One particular performance concern for large multiple processor systems is the impact on latency when one processor requests a line that is cached by another processor. If a modified (dirty) line is cached by a first processor, and the line is requested by a second processor, the line is written to main memory, and is also transferred to the requesting cache (called a cache-to-cache transfer). For a large multiple-processor system, a cache-to-cache transfer may require a longer latency than a transfer from main memory. In addition, for a large multiple-processor system, a cache-to-cache transfer may generate traffic on local buses that would not be required for a transfer from main memory. Accordingly, average latency can improved by reducing the number of cache-to-cache transfers, which in turn can be improved by preemptive eviction of stale dirty lines.

In addition, for large systems, even if a line in another processor's cache is not dirty, there may be substantial latency involved in determining whether the line is actually dirty. For example, in the MSI coherency protocol, if a line is in the Modified state, one processor may modify the line without informing any other processor. A line in the Modified state a cache may actually be clean, which means that the copy in main memory may be used, but a substantial time may be required to determine whether the line is clean or dirty. Therefore, average latency may be improved by preemptive eviction of stale lines in the Modified state, even if they are clean.

Systems for determining the age of dirty lines are known. For example, U.S. Pat. No. 6,134,634 describes a system in which each line in a cache has an associated counter that is used to count cycles during which the line has not been written. If the count exceeds a predetermined number, the line is determined to be stale and may be evicted. There is a need for lower cost identification of stale lines.

### SUMMARY OF THE INVENTION

In an example embodiment of the invention, a cache system can identify stale lines, with very little incremental circuitry. In particular, the example cache system can determine that a predetermined time has elapsed since a line of the cache has been accessed (or alternatively, modified), with only a single bit per line instead of a multiple bit counter or timer per line. A single age-bit may provided for each line in the cache, or a single age-bit may be provided for each index. The age-bits are initially set to a first logical state. Each time a line, or index, is accessed (or alternatively, written), by a processor, the corresponding age-bit is reset to the first logical state. A state machine periodically checks the status of each age-bit. If the state machine detects that an age-bit is in the first logical state, the state machine sets the age-bit to a second logical state. If the state machine detects that an age-bit is already in the second logical state, then the set of lines corresponding to the index corresponding to the age-bit, or line of data corresponding to the age-bit, has not been accessed or changed since the last time the state machine checked the age-bit, and is therefore, stale. If there is one age-bit per line, the line may be preemptively evicted. If there is one age-bit per index value, a replacement algorithm may be used to determine a line to evict, for example, the least-recently-used line corresponding to the index.

### BRIEF DESCRIPTION OF THE DRAWINGS

FIG. 1 is a block diagram of an example system that includes the invention.

FIGS. 2A and 2B are flow charts of event-driven methods in accordance with part of an example embodiment of the invention.

FIG. 3 is a flow chart of a method in accordance with part of an example embodiment of the invention.

### DETAILED DESCRIPTION OF THE PREFERRED EMBODIMENT OF THE INVENTION

If a cache stores an entire line address along with the data, and any line can be placed anywhere in the cache, the cache is said to be fully associative. However, for a large cache in which any line can be placed anywhere, the hardware required to rapidly determine if an entry is in the cache (and where) may be very large and expensive. For large caches, a faster, space saving alternative is to use a subset of an address (called an index) to designate a set of lines within the cache, and then store the remaining set of more significant bits of each physical address (called a tag) along with the data. In a cache with indexing, an item with a particular address can be placed only within a set of lines designated by the index. If the cache is arranged so that the index for a given address maps to exactly one line in the subset, the cache is said to be direct mapped. If the index maps to more than one line in the subset, the cache is said to be set-associative. All or part of an address is hashed to provide a set index which partitions the address space into sets.

In many computer memory architectures, a processor produces virtual addresses that are translated by a combination of hardware and software to physical addresses, which access physical main memory. A group of virtual addresses may be dynamically assigned to each page. Virtual memory (paging or segmentation) requires a data structure, sometimes called a page table, that translates the virtual address to the physical address. To reduce address translation time, computers commonly use a specialized associative cache dedicated to address translation, commonly called a Translation Look-aside Buffer (TLB).

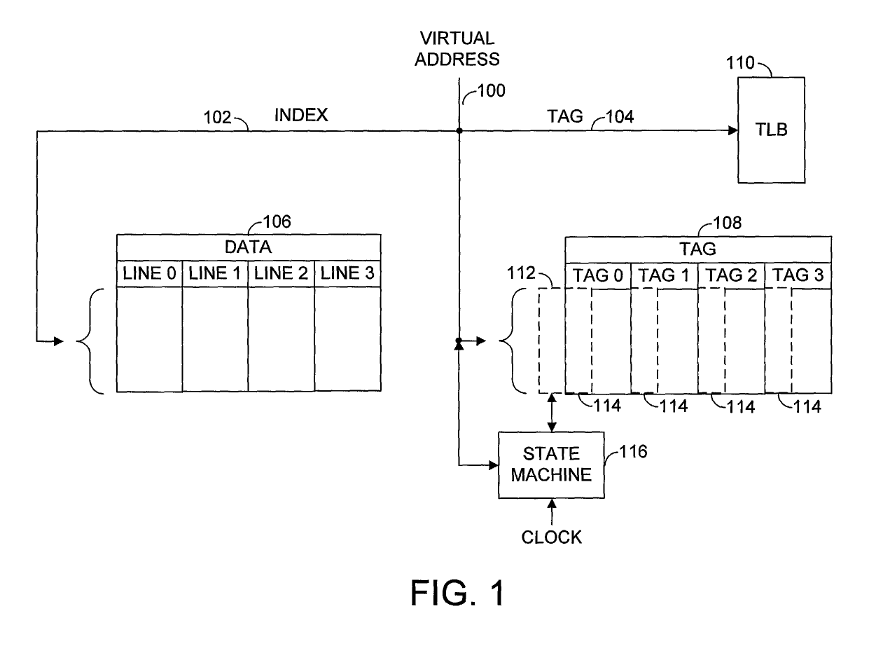

FIG. 1 illustrates an example cache system in which the invention may be implemented. The specific example cache illustrated in FIG. 1 is a four-way set-associative cache with virtual addressing. However, the invention is applicable to any cache configuration, including direct mapped caches, fully associative caches, or other configurations of set associative caches. In the example of FIG. 1, a virtual address 100 comprises lower order index bits 102 and upper order tag bits 104. The index bits are typically the same for the virtual address and the physical address. The index bits are used to select one set of lines of data in the data section 106 of the cache. The output of data section 106 is four lines of data. The index bits are also used to select a set of physical tags in a tag section 108 of the cache. The output of the tag section 108 is four physical tags, each corresponding to one data line. The TLB 110 stores both virtual and physical tags. For a TLB hit, the TLB provides a physical tag that corresponds to the virtual tag 104. Each of four digital comparators (not illustrated) then compares the physical tag from the TLB to a physical tag from the tag section 108. A matching pair of physical tags indicates through logic (not illustrated) which one of four lines of data is selected by a multiplexer (not illustrated). Note that for the particular index bits there may not be a matching pair of physical tags, in which case there is a cache miss. A fully associative cache may have a structure similar to a TLB to determine whether a line is in the cache, and where.

In accordance with the invention, age-bits are used to indicate whether lines in the cache may be stale. An age-bit is associated with each possible index value, or alternatively with each line in the cache. In FIG. 1, box 112 indicates a set of age-bits, with each age-bit associated with one index value. Boxes 114 indicate an alternative design, with four sets of age-bits, with each age-bit associated with one line of data. For a fully associative cache, each age-bit would be associated with one line of data. In a direct mapped cache, each age-bit would be associated with both one index value and with one line of data. It is not necessary for the age-bits to be physically located in the tag section 108 of the cache. It is only necessary to have a one-to-one relationship with index values, or alternatively with data lines. It is common to store cache coherency information in the tag section 108, so that age-bits can be added to the tag section with little incremental hardware. In addition, for some processor architectures, the tag section 108 may be integrated onto the processor chip, and the data structure 106 may be on a separate chip. If the tag structure 108 is an integral part of the processor, access times for age-bits is decreased, facilitating manipulation of age-bits during the latency for data retrieval. For a fully associative cache, the age-bits may be physically located with the TLB-like structure used to determine whether a line of data is in the cache.

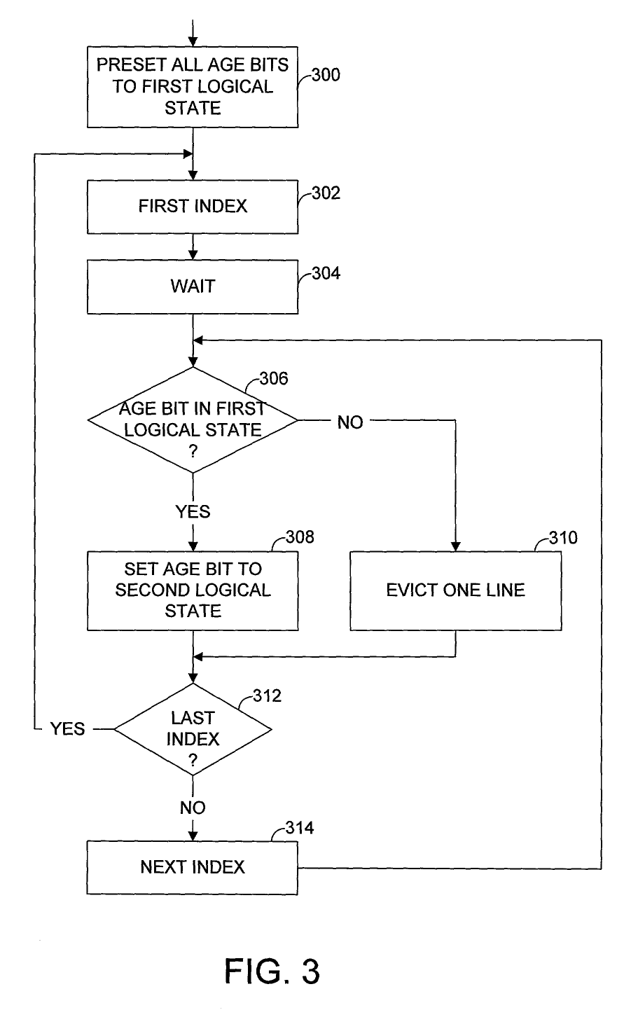

A state machine 116 periodically cycles through all the age-bits, as discussed in more detail in conjunction with FIG. 3. For purposes of illustration only, in FIG. 1, the state machine 116 is shown as interacting with age-bits 112 associated with each index value. If the age-bits are associated with every line of the data (age-bits 114), then the state machine would interact with age-bits 114.

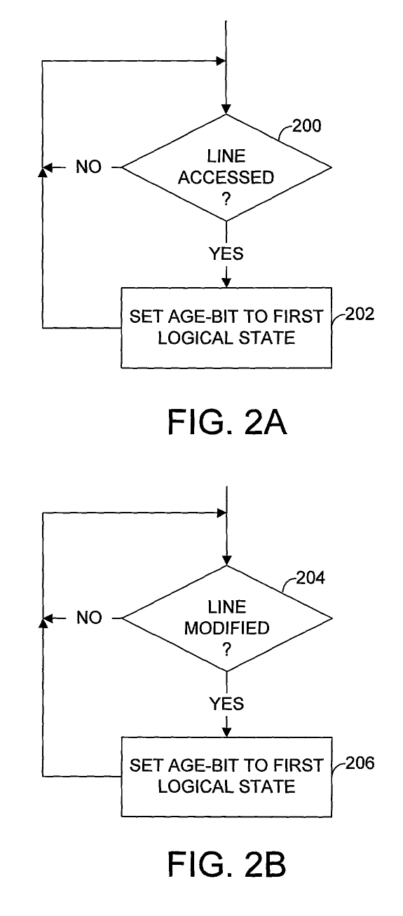

FIGS. 2A and 2B illustrate example alternative event driven methods, and FIG. 3 illustrates an example method for the state machine (FIG. 1, 116). All the age-bits are initially preset to a first logical state (for example, logical ZERO) (FIG. 3, 300). The age-bits may then be used to detect whether a line has been accessed (read or write) (FIG. 2A), or alternatively whether a line has been modified (write only) (FIG. 2B). If the goal is to identify stale lines, then each time a line is accessed (FIG. 2A, 200), the corresponding age-bit is set to the first logical state (FIG. 2A, 202). Alternatively, if the goal is to identify stale dirty lines, each time a line is modified (written) (FIG. 2B, 204), the corresponding age-bit is set to the first logical state (FIG. 2B, 206). If the age-bits are physically part of the cache, they may be set to the first logical state by the cache. If the age-bits are physically separate from the cache, the state machine (FIG. 1, 116) may receive the index value and the state machine may set the corresponding age-bit to the first logical state.

FIG. 3 illustrates an example method for the state machine (FIG. 1, 116), assuming that there is one age-bit for each index value (FIG. 1, 112). At step 300, each age-bit is initialized to a first logical state, for example, logical ZERO. The index is initialized at step 302. The state machine then waits for a predetermined amount of time (step 304) before checking the status of the age-bits. The state machine then cycles repeatedly through all index values. At step 306, for each index value, the state machine examines the state of the corresponding age-bit. If the age-bit is in the first logical state, then at step 308, the state machine sets the age-bit to a second logical state (for example, logical ONE).

If the age-bit is already in the second logical state, at step 310, one line in the set of lines corresponding to the index value may be evicted. In a set associative cache, there are multiple lines that correspond to the index value, and the system must determine which of the multiple lines to evict. There may be more than one stale line corresponding to the index value. It is common for caches to have a replacement algorithm, for example, least-recently-used. For the example of a four-way set-associative cache, the replacement algorithm may be used to select one of four lines associated with an index value having a corresponding age-bit in the second logical state. There are several alternatives. If the goal is to detect and evict stale lines, then the replacement algorithm may be used to select any of the lines corresponding to the index value. In particular, if the replacement algorithm is least-recently-used, a stale line will be evicted. If the goal is to detect stale dirty lines, then the replacement algorithm may be limited to just the modified lines corresponding to the index value.

Steps 312 and 314 cycle steps 306-310 through all the index values, and then execute the wait period (step 304) before repeating the cycle.

In the example embodiment of FIG. 3, the wait time 304 is a minimum wait time, and the overall cycle time for checking status for any particular age-bit may be longer than the minimum wait time by a variable amount. For example, it may be preferably to execute the index loop (FIG. 3, steps 306-314) only when the cache is otherwise idle, so the total cycle time for checking the status for any one age-bit may depend on how busy the cache is. In addition, recall that each time a line is accessed (or alternatively, each time a line is written), the corresponding age-bit is set to the first logical state. As a result, setting age-bits to the first logical state (FIGS. 2A and 2B) is asynchronous to the method of FIG. 3. Accordingly, the time between when an age-bit is set to the first logical state, and the time at which it is checked by the state machine, is variable. As an alternative, setting age-bits to the first logical state could be made synchronous, for example by delaying setting age-bits until just before or after step 304 of FIG. 3, and the state machine could be implemented with non-variable cycle times.

If there is one age-bit per line (FIG. 1, 114), for the example of a four-way set-associative cache, then the system using the example method of FIG. 3 could repeat steps 306 through 310 four times, once for each of four age-bits associated with each index value. For a fully associative cache, the system could cycle through the entries in a look-up structure (for example, a content-addressable-memory) instead of index values.

In the resulting cache system, stale lines, or alternatively stale dirty lines, can be identified by adding only one bit for each of the number of index values in the cache, or one bit for each of the number of lines in the cache, plus a state machine.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of evicting an entry in a cache memory, comprising:
setting a bit to a first logical state when the entry is accessed;
setting the bit to a second logical state; and
evicting the entry when the bit is at the second logical state after at least a predetermined time after being set to the second logical state.

2. A method of evicting an entry in a cache memory, comprising:
setting a bit to a first logical state when the entry is written;
setting the bit to a second logical state; and
evicting the entry when the bit is at the second logical state after at least a predetermined time after being set to the second logical state.

3. A method of evicting at least one entry in a set of entries in a cache memory, comprising:
setting a bit to a first logical state when an entry corresponding to an index is accessed;
setting the bit to a second logical state; and
evicting at least one entry corresponding to the index when the bit is at the second logical state after at least a predetermined time after being set to the second logical state.

4. A method of evicting at least one entry in a set of entries in a cache memory, comprising:
setting a bit to a first logical state when an entry corresponding to an index is modified;
setting the bit to a second logical state; and
evicting at least one entry corresponding to the index when the bit is at the second logical state after at least a predetermined time after being set to the second logical state.
